(19) United States
(12) Patent Application Publication
(10) Pub. No.: US 2025/0253520 A1
(43) Pub. Date: Aug. 7, 2025

(54) ANTENNA MODULE AND ELECTRONIC DEVICE COMPRISING ANTENNA MODULE

(71) Applicant: Samsung Electronics Co., Ltd., Suwon-si (KR)

(72) Inventors: Jaehoon JO, Suwon-si (KR); Seongjin PARK, Suwon-si (KR); Hosaeng KIM, Suwon-si (KR); Sumin YUN, Suwon-si (KR)

(21) Appl. No.: 19/187,288

(22) Filed: Apr. 23, 2025

Related U.S. Application Data
(63) Continuation of application No. PCT/KR2023/018135, filed on Nov. 13, 2023.

(30) Foreign Application Priority Data
Nov. 14, 2022 (KR) 10-2022-0151810
Dec. 28, 2022 (KR) 10-2022-0186783

(51) Int. Cl. H01Q 1/24; H01Q 1/48; H01Q 1/52; H01Q 9/04; H01Q 21/08

(52) U.S. Cl. CPC H01Q 1/243; H01Q 1/48; H01Q 1/526; H01Q 9/0407; H01Q 21/08

(57) ABSTRACT

An electronic device is provided. The electronic device includes a housing including a first surface, a second surface and a side surface, surrounding a space between the first surface and the second surface, and an antenna module disposed inside the housing, wherein the antenna module includes a wireless communication circuit, a first substrate including a first surface oriented in a first direction and a second surface oriented in a second direction opposite to the first direction, wherein, on the first substrate, first antenna elements and first portions of second antenna elements are disposed, a second substrate disposed at a first position on the second surface of the first substrate, wherein second portions of the second antenna elements are disposed on the second substrate, and a shield member disposed adjacent to the second substrate at a second position on the second surface of the first substrate, and wherein a portion of the shielding member is configured to serve as a ground for the second portions of the second antenna elements.

### CROSS-REFERENCE TO RELATED APPLICATION(S)

This application is a continuation application, claiming priority under 35 U.S.C. § 365 (c), of an International application No. PCT/KR2023/018135, filed on Nov. 13, 2023, which is based on and claims the benefit of a Korean patent application number 10-2022-0151810, filed on Nov. 14, 2022, in the Korean Intellectual Property Office, and of a Korean patent application number 10-2022-0186783, filed on Dec. 28, 2022, in the Korean Intellectual Property Office, the disclosure of each of which is incorporated by reference herein in its entirety.

### BACKGROUND

### 1. Field

The disclosure relates to an antenna module and an electronic device including the same.

### 2. Description of Related Art

Usage of electronic devices, such as bar-type, foldable-type, rollable-type, sliding-type, or wearable-type devices is increasing, and various functions are being provided to such electronic devices.

Such an electronic device may transmit and receive a phone call and various data to and from another electronic device through wireless communication.

Such an electronic device may include at least one antenna module in order to perform long-range and/or short-range communication with another electronic device. For example, an electronic device may include at least one antenna module capable of supporting a high-frequency band (e.g., about 3 GHz to 300 GHz).

The electronic device may implement a wireless communication function corresponding to a 5^{th} generation (5G) communication band by using at least one antenna module.

The above information is presented as background information only to assist with an understanding of the disclosure. No determination has been made, and no assertion is made, as to whether any of the above might be applicable as prior art with regard to the disclosure.

### SUMMARY

The next-generation wireless communication technology may transmit and receive wireless signals by using a frequency band in the range of about 3 GHz to 300 GHz.

An electronic device may include at least one antenna module in order to perform 5^{th} generation (5G) communication (e.g., millimeter wave (mmWave) communication). For example, at least one antenna module may be disposed in an internal space of a housing of the electronic device (e.g., a side surface bezel structure).

As functions provided by the electronic device become more diverse, the number of electronic components mounted in the electronic device tends to increase.

With the increase in the number of electronic components mounted in the electronic device, available space for placing an antenna module may become insufficient. For example, the larger the antenna module is, the less space may remain for mounting other electronic components inside the electronic device.

The antenna module may, for example, be required to provide a ground area for an antenna array (e.g., a patch antenna) disposed on a side surface of a substrate, and thus there may be limitations in reducing the width of the substrate in one direction (e.g., a horizontal direction).

Aspects of the disclosure are to address at least the above-mentioned problems and/or disadvantages and to provide at least the advantages described below. Accordingly, an aspect of the disclosure is to provide an electronic device in which at least a portion of a shielding member (e.g., a shield can) included in an antenna module is utilized as a ground area for an antenna array disposed on a side surface of the antenna module.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first surface, a second surface, and a side surface surrounding a space between the first surface and the second surface, and an antenna module disposed inside the housing, wherein the antenna module includes a wireless communication circuit, a first substrate including a first surface oriented in a first direction and a second surface oriented in a second direction opposite to the first direction, wherein, on the first substrate, first antenna elements and first portions of second antenna elements are disposed, a second substrate disposed at a first position of the second surface of the first substrate, wherein second portions of the second antenna elements are disposed on the second substrate, and a shielding member disposed adjacent to the second substrate at a second position of the second surface of the first substrate, and wherein a portion of the shielding member is configured to serve as a ground for the second portions of the second antenna elements.

According to various embodiments of the disclosure, the width of a substrate in one direction (e.g., a direction horizontal to the second surface) may be reduced by utilizing at least a portion of a conductive shielding member included in an antenna module as a ground area for an antenna array (e.g., a patch antenna) disposed on a side surface of the antenna module.

According to various embodiments of the disclosure, the size of an antenna module may be reduced by utilizing at least a portion of a conductive shielding member included in the antenna module as a ground area for an antenna array disposed on a side surface of the antenna module.

In accordance with an aspect of the disclosure, an antenna module is provided. The antenna module includes a wireless communication circuit, a first substrate comprising a first surface oriented in a first direction and a second surface oriented in a second direction opposite to the first direction, wherein, on the first substrate, first antenna elements and first portions of second antenna elements are disposed, a second substrate disposed at a first position of the second surface of the first substrate, wherein, on the second substrate, second portions of the second antenna elements are disposed, and a shielding member disposed adjacent to the second substrate at a second position of the second surface of the first substrate, wherein a portion of the shielding member is configured to serve as a ground for the second portions of the second antenna elements.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device for supporting legacy network communication and 5G network communication according to an embodiment of the disclosure;

FIG. 3A is a front perspective view of an electronic device according to an embodiment of the disclosure;

FIG. 3B is a rear perspective view illustrating an electronic device of FIG. 3A according to an embodiment of the disclosure;

FIG. 3C is an exploded perspective view illustrating an electronic device of FIG. 3A according to an embodiment of the disclosure;

FIG. 4A is a view illustrating an embodiment of a structure of a third antenna module described with reference to FIG. 2 according to an embodiment of the disclosure;

FIG. 4B is a cross-sectional view taken along line Y-Y′ of a third antenna module illustrated in part (a) of FIG. 4A according to an embodiment of the disclosure;

FIG. 5 is a perspective view schematically illustrating an antenna module according to an embodiment of the disclosure;

FIG. 6 is a schematic cross-sectional view taken along line A-A′ of an antenna module illustrated in FIG. 5 according to an embodiment of the disclosure;

FIG. 7 is a perspective view schematically illustrating an antenna module according to an embodiment of the disclosure; and

FIG. 8 is a schematic cross-sectional view taken along line B-B′ of an antenna module illustrated in FIG. 7 according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (A P, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

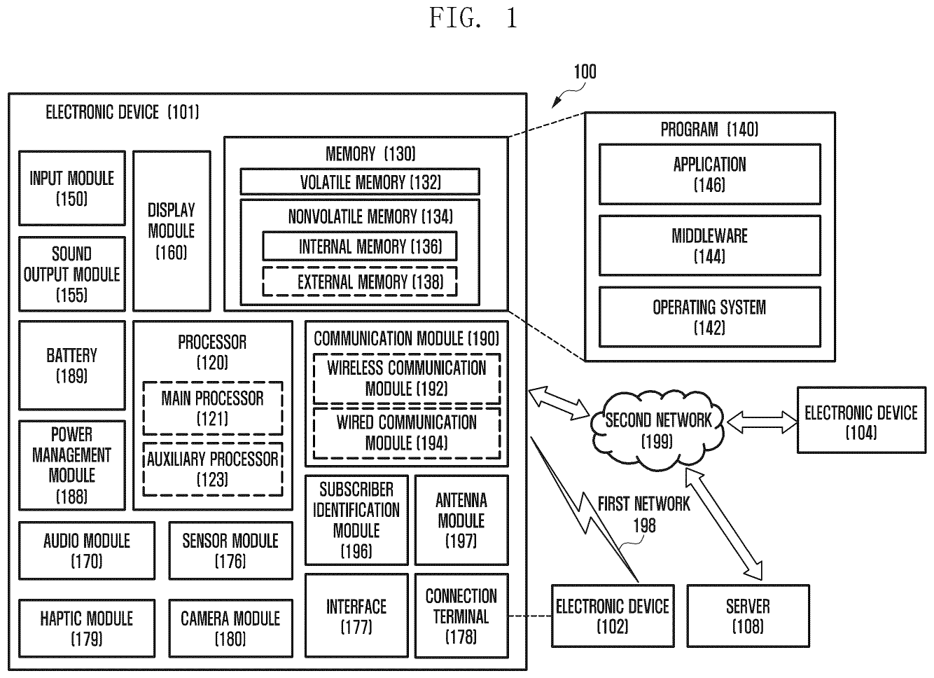

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eM BB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eM BB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

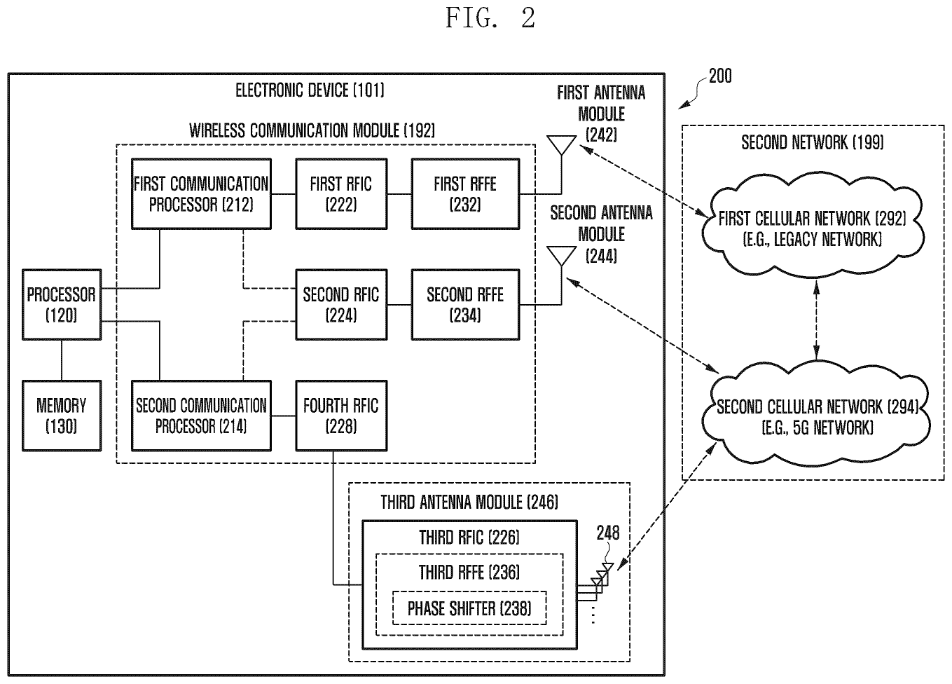

FIG. 2 is a block diagram 200 of an electronic device configured to support a legacy network communication and a 5G network communication according to an embodiment of the disclosure.

Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include a processor 120 and memory 130. The second network 199 may include a first cellular network 292 (e.g., a legacy network) and a second cellular network 294 (e.g., a 5G network). According to another embodiment of the disclosure, the electronic device 101 may further include at least one of the components illustrated in FIG. 1, and the second network 199 may further include one or more other networks. According to an embodiment of the disclosure, the first communication processor 212, the second communication processor 214, the first RFIC 222, the second RFIC 224, the fourth RFIC 228, the first RFFE 232, and the second RFFE 234 may constitute at least a portion of an RF communication module 192. According to another embodiment of the disclosure, the fourth RFIC 228 may be omitted, or may be included as a portion of the third RFIC 226.

The first communication processor 212 may establish a communication channel in a band to be used for RF communication with the first cellular network 292, and may support legacy network communication via the established communication channel. According to various embodiments of the disclosure, the first cellular network may be a legacy network including a 2^{nd} generation (2G), 3^{rd} generation (3G), 4G, or long-term evolution (LTE) network. The second communication processor 214 may establish a communication channel corresponding to a predetermined band (e.g., about 6 GHz to about 60 GHz) in a band to be used for RF communication with the second cellular network 294, and may support 5G network communication via the established communication channel. According to various embodiments of the disclosure, the second cellular network 294 may be a 5G network defined in the third generation partnership project (3GPP). In addition, according to an embodiment of the disclosure, the first communication processor 212 or the second communication processor 214 may establish a communication channel corresponding to another predetermined band (e.g., about 6 GHz or lower) in the band to be used for RF communication with the second cellular network 294, and may support 5G network communication through the established communication channel. According to an embodiment of the disclosure, the first communication processor 212 and the second communication processor 214 may be implemented in a single chip or in a single package. According to various embodiments of the disclosure, the first communication processor 212 or the second communication processor 214 may be formed in a single chip or a single package with the processor 120, an auxiliary processor 123, or a communication module 190.

During transmission, the first RFIC 222 may convert a baseband signal generated by the first communication processor 212 into an RF signal of about 700 M Hz to about 3 GHz to be used in the first cellular network 292 (e.g., a legacy network). During reception, an RF signal may be acquired from the first cellular network 292 (e.g., the legacy network) through an antenna (e.g., the first antenna module 242), and may be pre-processed through an RFFE (e.g., the first RFFE 232). The first RFIC 222 may convert the pre-processed RF signal into a baseband signal to be processed by the first communication processor 212.

During transmission, the second RFIC 224 may convert the baseband signal generated by the first communication processor 212 or the second communication processor 214 into an RF signal in a Sub6 band (e.g., about 6 GHz or lower) (hereinafter, referred to as “5G Sub6 RF signal”) to be used in the second cellular network 294 (e.g., a 5G network). During reception, the 5G Sub6 RF signal may be acquired from the second cellular network 294 (e.g., a 5G network) through an antenna (e.g., the second antenna module 244), and may be pre-processed through an RFFE (e.g., the second RFFE 234). The second RFIC 224 may convert the pre-processed 5G Sub6 RF signal into a baseband signal so as to be processed by a corresponding one of the first communication processor 212 and the second communication processor 214.

The third RFIC 226 may convert the baseband signal generated by the second communication processor 214 into an RF signal in a 5G Above6 band (e.g., about 6 GHz to about 60 GHZ) (hereinafter, referred to as a “5G Above6 RF signal”) to be used in the second cellular network 294 (e.g., a 5G network). During reception, the 5G Above6 RF signal may be acquired from the second cellular network 294 (e.g., a 5G network) through an antenna (e.g., the antenna 248), and may be pre-processed through the third RFFE 236. The third RFIC 226 may convert the pre-processed 5G Above6 RF signal into a baseband signal to be processed by the second communication processor 214. According to an embodiment of the disclosure, the third RFFE 236 may be provided as a portion of the third RFIC 226.

According to an embodiment of the disclosure, the electronic device 101 may include a fourth RFIC 228 separately from or as at least a portion of the third RFIC 226. In this case, the fourth RFIC 228 may convert the baseband signal generated by the second communication processor 214 into an RF signal (hereinafter, referred to as an “IF signal”) in an intermediate-frequency band (e.g., about 9 GHz to about 11 GHz), and may then deliver the IF signal to the third RFIC 226. The third RFIC 226 may convert the IF signal into a 5G Above6 RF signal. During reception, the 5G Above6 RF signal may be received from the second cellular network 294 (e.g., a 5G network) through an antenna (e.g., the antenna 248), and may be converted into an IF signal through the third RFIC 226. The fourth RFIC 228 may convert the IF signal into a baseband signal to be capable of being processed by the second communication processor 214.

According to an embodiment of the disclosure, the first RFIC 222 and the second RFIC 224 may be implemented as at least a portion of a single chip or a single package. According to an embodiment of the disclosure, the first RFFE 232 and the second RFFE 234 may be implemented as at least a portion of a single chip or a single package. According to an embodiment of the disclosure, at least one of the first antenna module 242 and the second antenna module 244 may be omitted, or may be combined with another antenna module to process RF signals of a plurality of corresponding bands.

According to an embodiment of the disclosure, the third RFIC 226 and the antenna 248 may be disposed on the same substrate so as to form a third antenna module 246. For example, the RF communication module 192 or the processor 120 may be placed on a first substrate (e.g., a main PCB). In such a case, the third RFIC 226 may be disposed on a partial area (e.g., the bottom surface) of a second substrate (e.g., a sub-PCB) separate from the first substrate, and the antenna 248 may be disposed on another partial area (e.g., the top surface), thereby providing the third antenna module 246. By disposing the third RFIC 226 and the antenna 248 on the same substrate, it is possible to reduce the length of the transmission line therebetween. Through this, it is possible to reduce the loss (e.g., attenuation) of signals in a high-frequency band (e.g., about 6 GHz to about 60 GHZ) to be used for, for example, 5G network communication by the transmission line. As a result, the electronic device 101 is able to improve the quality or speed of communication with the second cellular network 294 (e.g., a 5G network).

According to an embodiment of the disclosure, the antenna 248 may be configured as an antenna array that includes a plurality of antenna elements capable of being used for beamforming. In this case, the third RFIC 226 may include a plurality of phase shifters 238 corresponding to the plurality of antenna elements, for example, as a portion of the third RFFE 236. During transmission, each of the plurality of phase shifters 238 may convert the phase of a 5G Above6 RF signal to be transmitted to the outside of the electronic device 101 (e.g., a base station of a 5G network) via a corresponding antenna element. During reception, each of the plurality of phase shifters 238 may convert the phase of the 5G Above6 RF signal received from the outside into the same or substantially the same phase via the corresponding antenna element. This enables transmission or reception through beamforming between the electronic device 101 and the outside.

The second cellular network 294 (e.g., a 5G network) may be operated independently from the first cellular network 292 (e.g., a legacy network) (e.g., standalone (SA)), or may be operated in the state of being connected to the first cellular network 292 (e.g., non-standalone (NSA)). For example, a 5G network may include only an access network (e.g., a 5G radio access network (RAN) or a next-generation RAN (NG RAN)) but may not include a core network (e.g., a next-generation core (NGC)). In this case, after accessing the access network of the 5G network, the electronic device 101 may access an external network (e.g., the Internet) under the control of the core network (e.g., an evolved packed core (EPC)) of a legacy network. Protocol information for communication with a legacy network (e.g., LTE protocol information) or protocol information for communication with a 5G network (e.g., new radio (NR) protocol information) may be stored in the memory 130, and may be accessed by another component (e.g., the processor 120, the first communication processor 212, or the second communication processor 214).

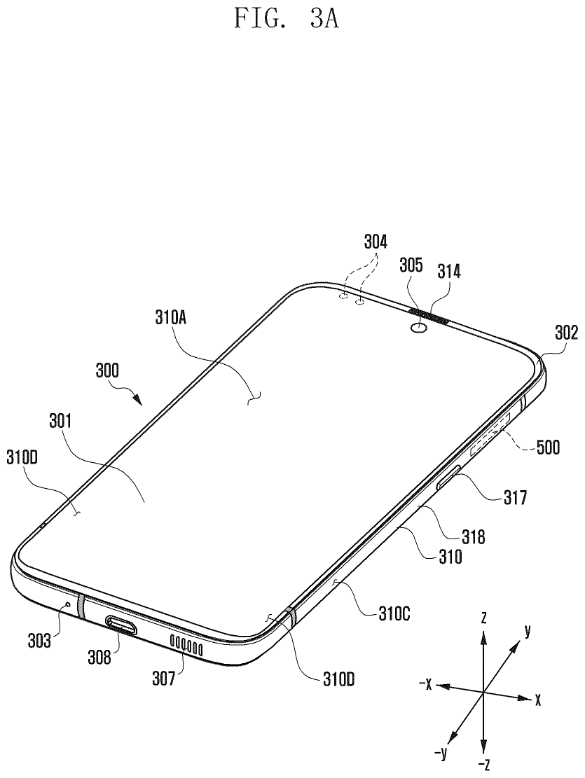

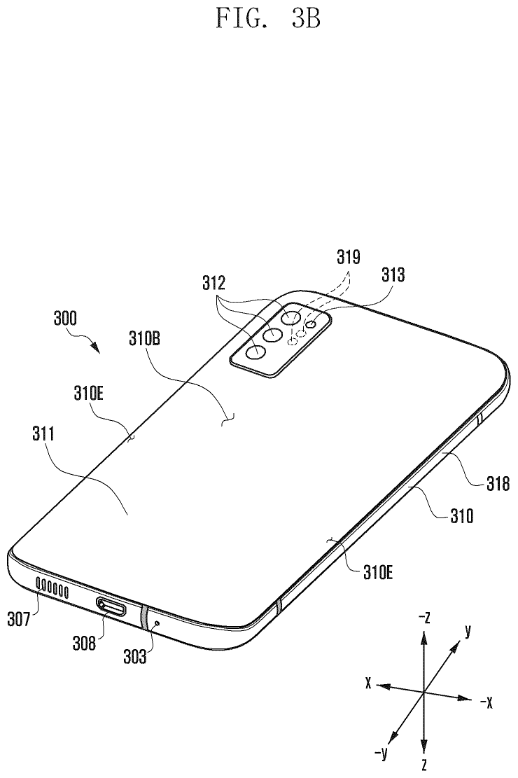

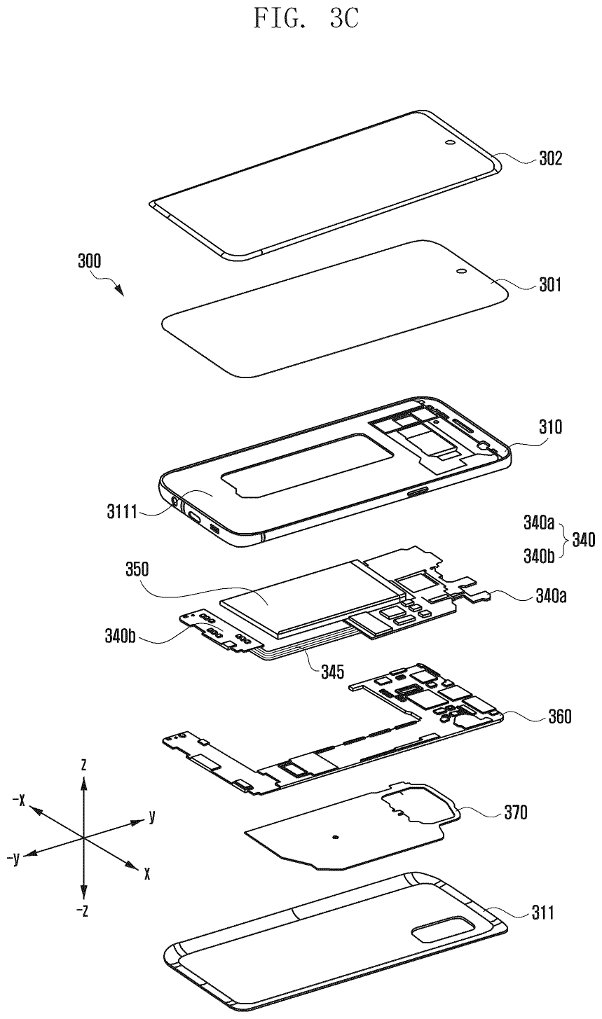

FIG. 3A is a front perspective view of an electronic device according to an embodiment of the disclosure. FIG. 3B is a rear perspective view of an electronic device according to an embodiment of the disclosure.

Referring to FIGS. 3A and 3B, an electronic device 300 according to an embodiment may include a housing 310 including a first surface (or front surface) 310A, a second surface (or rear surface) 310B, and a side surface 310C surrounding the space between the first surface 310A and the second surface 310B. In another embodiment (not illustrated), the housing may denote a structure that forms a part of the first surface 310A, the second surface 310B, and the side surface 310C illustrated in FIGS. 3A and 3B. According to an embodiment of the disclosure, the first surface 310A may be formed by a front plate 302, at least a part of which is substantially transparent (for example, a glass plate including various coating layers, or a polymer plate). The second surface 310B may be formed by a rear plate 311 that is substantially opaque. The rear plate 311 may be made of coated or colored glass, ceramic, polymer, metal (for example, aluminum, stainless steel (STS), or magnesium), or a combination of at least two of the above-mentioned materials. The side surface 310C may be formed by a side bezel structure (or “side member”) 318 which is coupled to the front plate 302 and to the rear plate 311, and which includes metal and/or polymer. In some embodiments of the disclosure, the rear plate 311 and the side bezel structure 318 may be formed integrally and may include the same material (for example, a metal material, such as aluminum).

In the illustrated embodiment of the disclosure, the front plate 302 may include two first areas 310D on both ends of the long edge of the front plate 302 such that the two first areas 310D bend from the first surface 310A toward the rear plate 311 and extend seamlessly. In the illustrated embodiment of the disclosure, the rear plate 311 may include two second areas 310E on both ends of the long edge such that the two second areas 310E bend from the second surface 310B toward the front plate 302 and extend seamlessly. In some embodiments of the disclosure, the front plate 302 (or the rear plate 311) may include only one of the first areas 310D (or the second areas 310E). In another embodiment of the disclosure, a part of the first areas 310D or the second areas 310E may not be included. In the above embodiments of the disclosure, when seen from the side surface of the electronic device 300, the side bezel structure 318 may have a first thickness (or width) on a part of the side surface, which does not include the first areas 310D or the second areas 310E as described above, and may have a second thickness that is smaller than the first thickness on a part of the side surface, which includes the first areas 310D or the second areas 310E.

According to an embodiment of the disclosure, the electronic device 300 may include at least one of a display 301, input module 303, sound output modules 307 and 314, sensor modules 304 and 319, camera modules 305, 312, and 313, a key input device 317, an indicator, and connector 308. In some embodiments of the disclosure, at least one of the constituent elements (for example, the key input device 317 or the indicator) of the electronic device 300 may be omitted, or the electronic device 300 may additionally include another constituent element.

The display 301 may be exposed through a corresponding part of the front plate 302, for example. In some embodiments of the disclosure, at least a part of the display 301 may be exposed through the front plate 302 that forms the first areas 310D of the side surface 310C and the first surface 310A. In some embodiments of the disclosure, the display 301 may have a corner formed in substantially the same shape as that of the adjacent outer periphery of the front plate 302. In another embodiment in order to increase the area of exposure of the display 301, the interval between the outer periphery of the display 301 and the outer periphery of the front plate 302 may be formed to be substantially identical.

The input module 303 may include a microphone hole. The input module may include a plurality of microphones arranged therein such that the direction of a sound can be detected in some embodiments. The sound output modules 307 and 314 may include an outer speaker hole 307 and a speech receiver hole 314. In some embodiments of the disclosure, the speaker holes 307 and 314 and the input module 303 may be implemented as a single hole, or a speaker may be included (for example, a piezoelectric speaker) without the speaker holes 307 and 314.

The sensor modules 304 and 319 may generate an electric signal or a data value corresponding to the internal operating condition of the electronic device 300 or the external environment condition thereof. The sensor modules 304 and 319 may include, for example, a first sensor module 304 (for example, a proximity sensor) arranged on the first surface 310A of the housing 310, and/or a second sensor module (not illustrated) (for example, a fingerprint sensor), and/or a third sensor module 319 (for example, an HRM sensor) arranged on the second surface 310B of the housing 310, and/or a fourth sensor module (for example, a fingerprint sensor). The fingerprint sensor may be arranged not only on the first surface 310A (for example, the display 301) of the housing 310, but also on the second surface 310B thereof. The electronic device 300 may further include a sensor module not illustrated, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or a luminance sensor 304.

The camera modules 305, 312, and 313 may include a first camera device 305 arranged on the first surface 310A of the electronic device 300, a camera device 312 arranged on the second surface 310B thereof, and/or a flash 313. The camera modules 305 and 312 may include a single lens or a plurality of lenses, an image sensor, and/or an image signal processor. The flash 313 may include, for example, a light-emitting diode or a xenon lamp. In some embodiments of the disclosure, two or more lenses (an infrared camera, a wide-angle lens, and a telephoto lens) and image sensors may be arranged on a single surface of the electronic device 300.

The key input device 317 may be arranged on the side surface 310C of the housing 310. In another embodiment of the disclosure, the electronic device 300 may not include a part of the above-mentioned key input device 317 or the entire key input device 317, and the key input device 317 (not included) may be implemented in another type, such as a soft key, on the display 301. In some embodiments of the disclosure, the key input device may include a sensor module arranged on the second surface 310B of the housing 310.

The indicator may be disposed, for example, on the first surface 310A of the housing 310. The indicator may provide, for example, the state information of the electronic device 300 in an optical form. In an embodiment of the disclosure, the light-emitting element may provide, for example, a light source that operates in conjunction with the operation of the camera module 305. The indicator may include, for example, an LED, an IR LED, and a xenon lamp.

The connector hole 308 may include a first connector hole 308 capable of accommodating a connector (e.g., a USB connector) configured to transmit/receive power and/or data to/from an external electronic device, and a second connector hole (e.g., an earphone jack) capable of accommodating a connector configured to transmit/receive an audio signal to/from an external electronic device.

Some camera modules 305 among the camera modules 305 and 312, some sensor modules 304 among the sensor modules 304 and 319, or the indicator may be disposed to be exposed through the display 301. For example, the camera module 305, the sensor module 304, or the indicator may be arranged in the internal space in the electronic device 300 to be in contact with the external environment through a through hole perforated in the display 301 up to the front plate 302. In an embodiment of the disclosure, some sensor module 304 may be disposed to execute their functions in the internal space of the electronic device 300 without being visually exposed through the front plate 302. For example, in this case, the area of the display 301 facing the sensor module may not require a through hole.

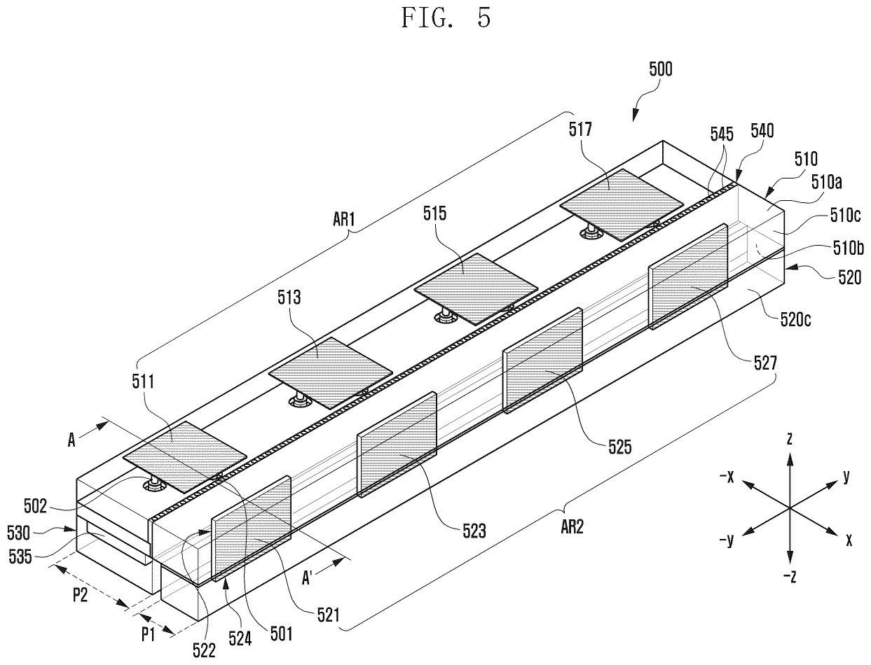

According to an embodiment of the disclosure, at least one antenna module 500 (e.g., the antenna module of FIG. 5) may be disposed at a predetermined position inside a housing 310 (e.g., a side surface member) of the electronic device 300. The antenna module 500 may be configured to perform 5^{th} generation (5G) communication (e.g., millimeter wave (mmWave) communication). For example, the antenna module 500 may transmit and/or receive a wireless signal using a frequency band in a range of about 3 GHz to 300 GHz.

FIG. 3C is an exploded perspective view of an electronic device according to an embodiment of the disclosure.

Referring to FIG. 3C, an electronic device 300 (e.g., the electronic device 101 of FIGS. 1 and 2, or the electronic device 300 of FIGS. 3A and/or 3B) may include a housing 310 (e.g., a side surface member), a first support member 3111 (e.g., a bracket or a support structure), a front plate 302 (e.g., a front surface cover), a display 301, a printed circuit board 340, a battery 350, a second support member 360 (e.g., a rear case), an antenna 370, and a rear plate 311 (e.g., a rear surface cover). In some embodiments of the disclosure, the electronic device 300 may omit at least one of the components (e.g., the first support member 3111 or the second support member 360) or may additionally include other components. At least one of the components of the electronic device 300 may be the same as or similar to at least one of the components of the electronic device 101 of FIGS. 1 and/or 2 or the electronic device 300 of FIGS. 3A and/or 3B, and redundant descriptions will be omitted below.

The first support member 3111 may be arranged inside the electronic device 300 and connected to the side bezel structure 318, or may be formed integrally with the side bezel structure 318. The first support member 311 may be made of a metal material and/or a nonmetal (for example, polymer) material, for example. The display 330 may be coupled to one surface of the first support member 311, and the printed circuit board 340 may be coupled to the other surface thereof.

For example, the printed circuit board 340 may include the processor 120, memory 130 and/or interface 177 disposed in the FIG. 1. For example, the processor may include one or more of a central processing unit, an application processor, a graphic processing unit, an image signal processor, a sensor hub processor, or a communication processor.

The memory may include volatile memory or non-volatile memory, for example.

The interface may include, for example, a high definition multimedia interface (HDMI), a universal serial bus (USB) interface, an SD card interface, and/or an audio interface. The interface may connect the electronic device 300 with an external electronic device electrically or physically, for example, and may include a USB connector, an SD card/MMC connector, or an audio connector.

The battery 350 is a device for supplying power to at least one constituent element of the electronic device 300, and may include a non-rechargeable primary cell, a rechargeable secondary cell, or a fuel cell, for example. At least a part of the battery 350 may be arranged on substantially the same plane with the printed circuit board 340, for example. The battery 350 may be arranged integrally inside the electronic device 300, or may be arranged such that the same can be attached to/detached from the electronic device 300.

The antenna 370 may be arranged between the rear plate 380 and the battery 350. The antenna 370 may include, for example, a near field communication (NFC) antenna, a wireless charging antenna, and/or a magnetic secure transmission (MST) antenna. The antenna 370 may conduct near-field communication with an external device or may wirelessly transmit/receive power necessary for charging, for example. In another embodiment of the disclosure, an antenna structure may be formed by a part or a combination of the side bezel structure 318 and/or the first support member 311.

According to various embodiments of the disclosure, the electronic device 300 of FIG. 3C may be at least partially similar to the electronic device 101 of FIG. 1 or FIG. 2 or the electronic device 300 of FIGS. 3A and/or 3B, or may include another embodiment of the electronic device.

According to various embodiments of the disclosure, the printed circuit board 340 may include a first PCB 340a and/or a second PCB 340b. For example, the first PCB 340a and the second PCB 340b may be spaced apart from each other and may be electrically connected by a connection member 345 (e.g., a coaxial cable and/or an FPCB). For example, the printed circuit board 340 may include a structure in which a plurality of printed circuit boards (PCBs) are stacked. For example, the printed circuit board 340 may include an interposer structure. In an embodiment of the disclosure, the printed circuit board 340 may be implemented in the form of a flexible printed circuit board (FPCB) and/or the form of a rigid printed circuit board (PCB).

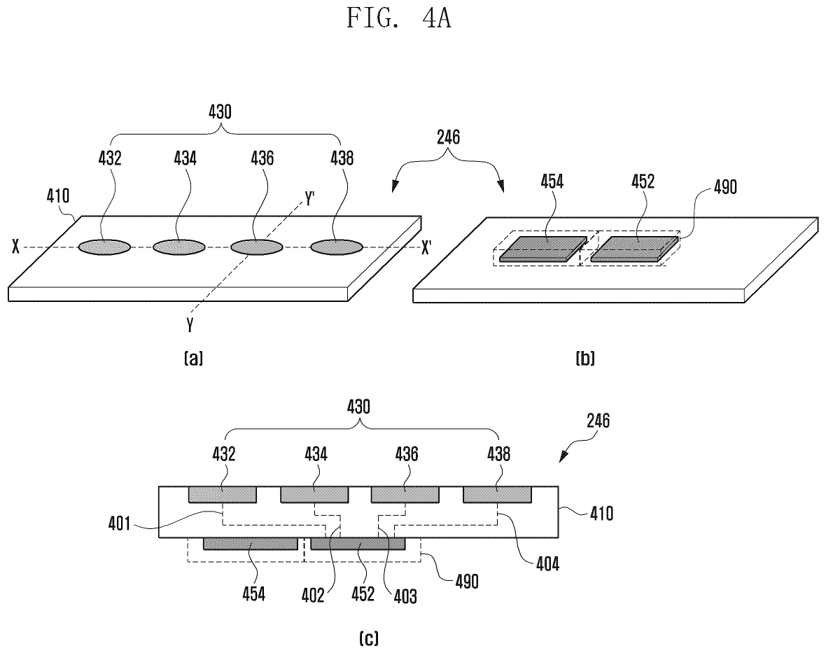

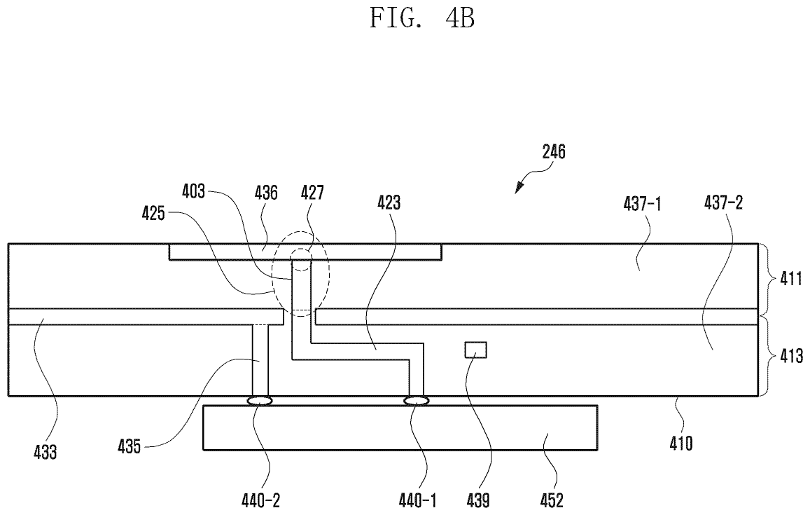

FIG. 4A is a view illustrating an embodiment of a structure of a third antenna module described with reference to FIG. 2 according to an embodiment of the disclosure.

Part (a) of FIG. 4A is a perspective view of the third antenna module 246 viewed from one side, and part (b) of FIG. 4A is a perspective view of the third antenna module 246 viewed from the other side. Part (c) of FIG. 4A is a cross-sectional view taken along line X-X′ of the third antenna module 246.

Referring to part (a) of FIG. 4A, in an embodiment of the disclosure, the third antenna module 246 may include a printed circuit board 410, an antenna array 430, a radio frequency integrated circuit (RFIC) 452, or a power manage integrated circuit (PMIC) 454. The third antenna module 246 may further include a shielding member 490. In an embodiment of the disclosure, at least one of the above-mentioned components may be omitted, or at least two of the components may be integrally formed.

The printed circuit board 410 may include a plurality of conductive layers and a plurality of non-conductive layers stacked alternately with the conductive layers. The printed circuit board 410 may provide electrical connections between various electronic components disposed on and/or outside the printed circuit board 410 using wiring lines and conductive vias formed in the conductive layers.

The antenna array 430 (e.g., the antenna 248 in FIG. 2) may include a plurality of antenna elements 432, 434, 436, or 438 (e.g., conductive patches) disposed to form directional beams. The antenna elements 432, 434, 436, or 438 may be disposed on a first surface (e.g., an upper surface) of the printed circuit board 410. The antenna array 430 may be disposed inside the printed circuit board 410. According to some embodiments of the disclosure, the antenna array 430 may include a plurality of antenna arrays having the same shape or different shapes and/or of different types (e.g., dipole antenna arrays and/or patch antenna arrays).

An RFIC 452 (e.g., the third RFIC 226 of FIG. 2) may be disposed in a different area of the printed circuit board 410 that is spaced apart from the antenna array 430 (e.g., a second surface, such as a lower surface, opposite to the first surface). The RFIC 452 may be configured to process signals of a selected frequency band that are transmitted and/or received through the antenna array 430. According to an embodiment of the disclosure, during transmission, the RFIC 452 may convert a baseband signal acquired from a communication processor (not illustrated) into an RF signal in a predetermined band. During reception, the RFIC 452 may convert an RF signal received through the antenna array 430 into a baseband signal and transmit the baseband signal to a communication processor.

According to an embodiment of the disclosure, during transmission, the RFIC 452 may up-convert an IF signal (e.g., about 9 GHz to about 11 GHZ) acquired from an intermediate frequency integrated circuit (IFIC) (e.g., the fourth RFIC 228 in FIG. 2) into an RF signal of a selected band. During reception, the RFIC 452 may down-convert an RF signal acquired via the antenna array 430 into an IF signal and transmit the IF signal to the IFIC.

According to an embodiment of the disclosure, the RFIC 452 may be electrically connected to a first antenna element 432 (e.g., a first conductive patch) via a first feeding line 401. The RFIC 452 may be electrically connected to a second antenna element 434 (e.g., a second conductive patch) via a second feeding line 402. The RFIC 452 may be electrically connected to a third antenna element 436 (e.g., a third conductive patch) via a third feeding line 403. The RFIC 452 may be electrically connected to a fourth antenna element 438 (e.g., a fourth conductive patch) via a fourth feeding line 404.

The PM IC 454 may be arranged in another partial area (e.g., the second surface) of the printed circuit board 410 spaced apart from the antenna array 430. The PM IC 454 may receive a voltage from a main PCB (e.g., the first PCB 340a in FIG. 3C) and provide power required for various components (e.g., the RFIC 452) disposed in the antenna module (e.g., the antenna module 500 in FIG. 5).

A shielding member 490 may be disposed on a portion (e.g., the second surface) of the printed circuit board 410 to electromagnetically shield at least one of the RFIC 452 and the PMIC 454. For example, the shielding member 490 may include a shield can.

According to various embodiments of the disclosure, the third antenna module 246 may be electrically connected to another printed circuit board (e.g., a main PCB) via a module interface. The module interface may include a connection member, for example, a coaxial cable connector, a board-to-board connector, an interposer, or a flexible printed circuit board (FPCB). The RFIC 452 and/or the PMIC 454 of the antenna module may be electrically connected to the printed circuit board via the connection member.

FIG. 4B is a cross-sectional view taken along line Y-Y′ of a third antenna module 246 illustrated in part (a) of FIG. 4A according to an embodiment of the disclosure.

According to an embodiment of the disclosure, the printed circuit board 410 may include an antenna layer 411 and a network layer 413.

Referring to FIG. 4B, the antenna layer 411 may include at least one dielectric layer 437-1 as well as an antenna element 436 (e.g., a third antenna element or third conductive patch) and/or a feeding portion 425 provided on the outer surface of the dielectric layer 437-1 or inside the dielectric layer 437-1. The feeding portion 425 may include a feeding point 427 and/or a feeding line 403 (e.g., a third feeding line).

According to an embodiment of the disclosure, the network layer 413 may include at least one dielectric layer 437-2, at least one ground layer 433 formed on or in an outer surface of the dielectric layer 437-2, at least one conductive via 435, a transmission line 423, and/or a signal line 439.

According to an embodiment of the disclosure, the RFIC 452 (e.g., the third RFIC 226 in FIG. 2) illustrated in part (c) of FIG. 4A may be electrically connected to the network layer 413 via, for example, first and second connection portions (solder bumps) 440-1 and 440-2. In various embodiments of the disclosure, in addition to the first connection portion 440-1 and the second connection portion 440-2, the RFIC 452 may use various connection structures (e.g., soldering or BGA). The RFIC 452 may be electrically connected to the antenna element 436 via the first connection portion 440-1, the transmission line 423, and the feeding portion 425. The RFIC 452 may be electrically connected to the ground layer 433 via the second connection portion 440-2 and the conductive via 435. In an embodiment of the disclosure, the RFIC 452 may be electrically connected to the above-described module interface via the signal line 439.

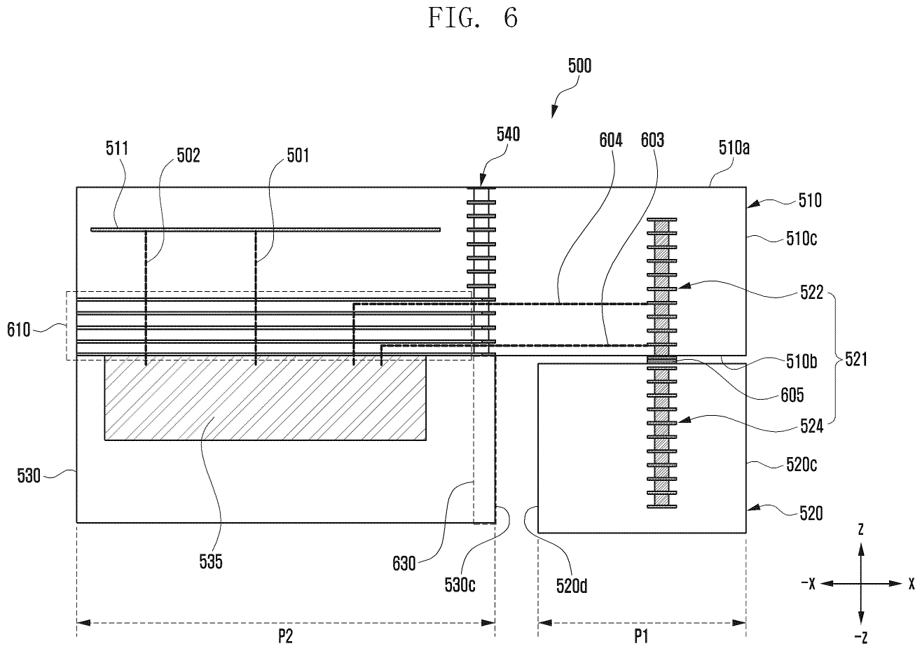

FIG. 5 is a perspective view schematically illustrating an antenna module according to an embodiment of the disclosure. FIG. 6 is a schematic cross-sectional view taken along line A-A′ of an antenna module illustrated in FIG. 5 according to an embodiment of the disclosure.

According to an embodiment of the disclosure, the antenna module 500 described below may include embodiments related to the antenna module 197 of FIG. 1 and the third antenna module 246 of FIGS. 2, 4A, and/or 4B. The antenna module 500 described below may be applicable to electronic devices, such as bar-type, foldable-type, rollable-type, sliding-type, wearable-type devices, tablet PCs, and/or laptop PCs.

According to an embodiment of the disclosure, the antenna module 500 may be disposed at a predetermined position inside a housing 310 (e.g., a side surface member) of the electronic device 300 illustrated in FIG. 3A. The antenna module 500 may be electrically connected to a printed circuit board 340 (e.g., a first PCB 340a) of the electronic device 300 illustrated in FIG. 3C using a signal connection member (e.g., a flexible printed circuit board (FPCB)).

According to an embodiment of the disclosure, the antenna module 500 may be configured to perform 5th generation (5G) communication (e.g., millimeter wave (mmWave) communication) using a frequency band in a range of about 3 GHz to 300 GHz.

Referring to FIGS. 5 and 6, an antenna module 500 according to an embodiment of the disclosure may include a first substrate 510, a second substrate 520, and/or a shielding member 530.

According to various embodiments of the disclosure, the first substrate 510 and the second substrate 520 may include a structure in which a plurality of printed circuit boards are stacked. The first substrate 510 and the second substrate 520 may include, for example, the printed circuit board 410 illustrated in FIG. 4A. The first substrate 510 and the second substrate 520 may include, for example, the antenna layer 411 and the network layer 413 illustrated in FIG. 4B. For example, the first substrate 510 and the second substrate 520 may include an interposer structure. For example, the first substrate 510 and the second substrate 520 may include a rigid PCB or an FPCB.

According to an embodiment of the disclosure, the first substrate 510 may include a first surface 510a (e.g., the upper surface) oriented in a first direction (e.g., the z-axis direction) and a second surface 510b (e.g., the lower surface) oriented in a second direction opposite to the first direction (e.g., the −z-axis direction). The first substrate 510 may include a logic circuit, a network layer (e.g., the network layer 413 of FIG. 4B), and/or at least one feeding line 501, 502, 603, or 604. A wireless communication circuit 535 may be disposed on the second surface 510b (e.g., the lower surface) of the first substrate 510. The second substrate 520 and the shielding member 530 may be disposed on the second surface 510b of the first substrate 510 (e.g., in the −z-axis direction). For example, the second substrate 520 may be disposed at a first position P1 of the second surface 510b of the first substrate 510 (e.g., in the x-axis direction), and the shielding member 530 may be disposed at a second position P2 of the second surface 510b of the first substrate 510 (e.g., in the −x-axis direction).

According to an embodiment of the disclosure, the first substrate 510 may include a first antenna array AR1 (e.g., first antenna elements 511, 513, 515, and 517). For example, the first substrate 510 may include a first antenna array AR1 disposed on or in an area adjacent to the first surface 510a (e.g., in the z-axis direction (the upper surface)). For example, the first antenna array AR1 may be disposed inside the first substrate 510. The first antenna array AR1 may include first antenna elements 511, 513, 515, and 517. For example, the first antenna array AR1 may be electrically connected to a wireless communication circuit 535 disposed in the shielding member 530 via a first feeding line 501 and/or a second feeding line 502. In an embodiment of the disclosure, the wireless communication circuit 535 may be disposed on the second surface 510b of the first substrate 510 (e.g., in the −z-axis direction). The wireless communication circuit 535 may include the RFIC 452 illustrated in FIGS. 4A and 4B. The wireless communication circuit 535 may transmit and/or receive a radio frequency in a range of about 3 GHz to 300 GHz using the first antenna array AR1.

According to various embodiments of the disclosure, the first antenna elements 511, 513, 515, and 517 of the first antenna array AR1 may be arranged at predetermined intervals on the first surface 510a of the first substrate 510 (e.g., in the z-axis direction) or in an area adjacent to the first surface 510a. For example, the first antenna elements 511, 513, 515, and 517 may be arranged on the first substrate 510 to form a beam pattern in the first direction (e.g., in the z-axis direction). The first antenna elements 511, 513, 515, and 517 may include a first conductive patch 511 (e.g., a first antenna element), a second conductive patch 513 (e.g., a second antenna element), a third conductive patch 515 (e.g., a third antenna element), and/or a fourth conductive patch 517 (e.g., a fourth antenna element).

According to various embodiments of the disclosure, the first conductive patch 511, the second conductive patch 513, the third conductive patch 515, and/or the fourth conductive patch 517 may have substantially the same shape or different shapes. The first conductive patch 511, the second conductive patch 513, the third conductive patch 515, and the fourth conductive patch 517 may receive a feeding signal from the wireless communication circuit 535 via at least one of, for example, a strip line, a microstrip line, a coplanar waveguide (CPW), or a via. For example, the first conductive patch 511, the second conductive patch 513, the third conductive patch 515, and the fourth conductive patch 517 may be electrically connected to the wireless communication circuit 535 via the first feeding line 501 and/or the second feeding line 502, and may transmit and/or receive a dual-polarized signal in the first direction (e.g., the z-axis direction) of the antenna module 500. For example, the dual-polarized signal may include a first polarized signal (e.g., a vertically polarized signal) and a second polarized signal (e.g., a horizontally polarized signal). In an embodiment of the disclosure, when only one polarization is supported, one of the first feeding line 501 and the second feeding line 502 may be omitted.

According to various embodiments of the disclosure, FIG. 6 may be a schematic view of the antenna module illustrated in FIG. 5 taken along line A-A′, as viewed in the −y-axis direction. The first feeding line 501 and the second feeding line 502 described above may be disposed at the same or different positions in the y-axis direction. For example, FIG. 6 may schematically represent an embodiment in which the first feeding line 501 and the second feeding line 502 are disposed at different positions in the y-axis direction.

According to various embodiments of the disclosure, the first antenna array AR1 may include the antenna array 430 illustrated in FIG. 4A. The first antenna elements 511, 513, 515, and 517 of the first antenna array AR1 may include the antenna elements 432, 434, 436, and 438 illustrated in FIG. 4A. In an embodiment of the disclosure, although the first substrate 510 of the antenna module 500 is described as including four conductive patches, it is not limited thereto and may include more or fewer conductive patches.

According to an embodiment of the disclosure, a first ground layer 610 may be disposed inside the first substrate 510. The first ground layer 610 may be disposed between the first antenna array AR1 and the second surface 510b of the first substrate 510. For example, the first ground layer 610 may include at least one layer. The first ground layer 610 may be disposed in parallel with the first antenna array AR1 disposed on the first substrate 510 (e.g., in a horizontal direction). The first ground layer 610 may be disposed to face the first antenna array AR1. The first ground layer 610 may be a ground area arranged for the radiation performance of the first antenna array AR1.

According to an embodiment of the disclosure, the first substrate 510 may include at least a portion of a second antenna array AR2 (e.g., second antenna elements 521, 523, 525, and 527). For example, the first substrate 510 may include the second antenna array AR2, at least a portion of which is disposed on the side surface 510c (e.g., in the x-axis direction) or in an area adjacent to the side surface 510c. For example, a first portion 522 of the second antenna array AR2 may be disposed inside the first substrate 510. The second antenna array AR2 may include second antenna elements 521, 523, 525, and 527. The first portion 522 of the second antenna array AR2 may be electrically connected to the wireless communication circuit 535 via a third feeding line 603 and/or a fourth feeding line 604.

According to various embodiments of the disclosure, the third feeding line 603 and the fourth feeding line 604 described above may be disposed at the same position or different positions in the y-axis direction. For example, FIG. 6 may schematically illustrate an embodiment in which the third feeding line 603 and the fourth feeding line 604 are disposed at different positions in the y-axis direction.

In an embodiment of the disclosure, the second substrate 520 may include at least a portion of the second antenna array AR2. For example, the second substrate 520 may include the second antenna array AR2, at least a portion of which is disposed on a side surface 520c (e.g., in the x-axis direction) or in an area adjacent to the side surface 520c. For example, second portions 524 of the second antenna array AR2 may be disposed inside the second substrate 520. The first portions 522 of the second antenna array AR2 may be disposed on the first substrate 510, and the second portions 524 may be disposed on the second substrate 520. The first portions 522 and the second portions 524 of the second antenna array AR2 may be electrically connected to each other via a conductive connection member 605 (e.g., solder). The wireless communication circuit 535 may transmit and/or receive a radio frequency in a range of about 3 GHz to 300 GHz using the second antenna array AR2.

According to various embodiments of the disclosure, the first portions 522 of the second antenna array AR2 may be arranged at predetermined intervals on a side surface 510c of the first substrate 510 (e.g., in the x-axis direction) or in an area adjacent to the side surface 510c. The first portion 522 of a fifth conductive patch 521 (e.g., a fifth conductive element) of the second antenna array AR2 may be disposed, for example, on the side surface 510c of the first substrate 510 or in an area adjacent to the side surface 510c. The second portions 524 of the second antenna array AR2 may be arranged at predetermined intervals on a side surface 520c of the second substrate 520 (e.g., in the x-axis direction) or in an area adjacent to the side surface 520c. The second portion 524 of the fifth conductive patch 521 (e.g., the fifth conductive element) of the second antenna array AR2 may be disposed, for example, on the side surface 520c of the second substrate 520 or in an area adjacent to the side surface 520c.

According to various embodiments of the disclosure, the second antenna elements 521, 523, 525, and 527 of the second antenna array AR2 may be disposed on the first substrate 510 and the second substrate 520 to form a beam pattern in the lateral direction (e.g., in the x-axis direction) of the antenna module 500. The second antenna elements 521, 523, 525, and 527 may include a fifth conductive patch 521 (e.g., a fifth antenna element), a sixth conductive patch 523 (e.g., a sixth antenna element), a seventh conductive patch 525 (e.g., a seventh antenna element), and/or an eighth conductive patch 527 (e.g., an eighth antenna element). For example, the fifth conductive patch 521 may include a first portion 522 and a second portion 524. The sixth conductive patch 523, the seventh conductive patch 525, and the eighth conductive patch 527 may each include a first portion 522 and a second portion 524 that are substantially the same as those of the fifth conductive patch 521. In an embodiment of the disclosure, the first portions 522 and the second portions 524 may be formed using vias.

According to various embodiments of the disclosure, the fifth conductive patch 521, the sixth conductive patch 523, the seventh conductive patch 525, and/or the eighth conductive patch 527 may have substantially the same shape or different shapes. The fifth conductive patch 521, the sixth conductive patch 523, the seventh conductive patch 525, and the eighth conductive patch 527 may receive a feeding signal from the wireless communication circuit 535 via at least one of, for example, a strip line, a microstrip line, a coplanar waveguide (CPW), or a via. For example, the fifth conductive patch 521, the sixth conductive patch 523, the seventh conductive patch 525, and the eighth conductive patch 527 may be electrically connected to the wireless communication circuit 535 via the third feeding line 603 and the fourth feeding line 604, and may transmit and/or receive a dual-polarized signal in the lateral direction (e.g., the x-axis direction) of the antenna module 500. For example, the dual-polarized signal may include a first polarized signal (e.g., a vertically polarized signal) and a second polarized signal (e.g., a horizontally polarized signal).

According to various embodiments of the disclosure, the second antenna array AR2 may include the antenna array 430 illustrated in FIG. 4A. The second antenna elements 521, 523, 525, and 527 of the second antenna array AR2 may include the antenna elements 432, 434, 436, and 438 illustrated in FIG. 4A. In various embodiments of the disclosure, the number of antenna elements arranged in the second antenna array AR2 of the antenna module 500 may be substantially the same as the number of antenna elements in the first antenna array AR1.

According to an embodiment of the disclosure, a second ground layer 540 may be disposed inside the first substrate 510. The second ground layer 540 may include at least one via 545. The second ground layer 540 may be disposed between the first antenna array AR1 and the second antenna array AR2. The second ground layer 540 may be formed using a plurality of vias 545. The second ground layer 540 may be formed in parallel (e.g., in a vertical direction) with the first portions 522 of the second antenna array AR2 disposed on a side surface 510c of the first substrate 510 (e.g., in the x-axis direction). The second ground layer 540 may be disposed to face the first portions 522 of the second antenna array AR2. The second ground layer 540 may be a ground area provided for the radiation performance of the first portions 522 of the second antenna array AR2.

In an embodiment of the disclosure, the second substrate 520 may be disposed at a first position P1 (e.g., in the x-axis direction) on the second surface 510b (e.g., in the −z-axis direction) of the first substrate 510. The shielding member 530 may be disposed at a second position P2 (e.g., in the −x-axis direction), which is a lateral direction from the first position P1 (e.g., in the x-axis direction), on the second surface 510b (e.g., in the −z-axis direction) of the first substrate 510. The second substrate 520 and the shielding member 530 may be disposed adjacent to each other. For example, the side surface 520d of the second substrate 520 and the side surface 530c of the shielding member 530 may be disposed to face each other.

In an embodiment of the disclosure, the shielding member 530 may include therein a wireless communication circuit 535, a power management module (e.g., the power management module 188 of FIG. 1), and/or at least one lumped element (e.g., a resistor, an inductor, and/or a capacitor). For example, the wireless communication circuit 535, the power management module (e.g., the power management module 188 of FIG. 1), and/or at least one lumped element (e.g., a resistor, an inductor, and/or a capacitor) may be enclosed by the shielding member 530.

According to various embodiments of the disclosure, the shielding member 530 may include a conductive material. For example, the shielding member 530 may include a conductive shield can. When the shielding member 530 is made of a conductive material, a portion 630 of the shielding member 530 may serve as a ground for the second portions 524 of the second antenna array AR2. For example, the portion 630 of the shielding member 530 may function as a third ground layer. The portion 630 of the shielding member 530 may be disposed between the wireless communication circuit 535 and the second portions 524 of the second antenna array AR2.

According to various embodiments of the disclosure, the shielding member 530 may include a non-conductive material and/or a conductive material. For example, the portion 630 of the shielding member 530 may include a conductive material. The conductive material included in the portion 630 of the shielding member 530 may serve as a ground (e.g., a third ground layer) for the second portions 524 of the second antenna array AR2. In an embodiment of the disclosure, the portion 630 of the shielding member 530 may be electrically connected to the second ground layer 540.

In an embodiment of the disclosure, the wireless communication circuit 535 disposed inside the shielding member 530 may be configured to process signals in a frequency band transmitted and/or received through the first antenna array AR1 and the second antenna array AR2. For example, during transmission, the wireless communication circuit 535 may convert a baseband signal and/or an intermediate frequency signal into a radio frequency (RF) signal of a predetermined band. During reception, the wireless communication circuit 535 may convert an RF signal received via the first antenna array AR1 and the second antenna array AR2 into a baseband signal and/or an intermediate frequency signal and output the converted signal. For example, referring to FIG. 6, the wireless communication circuit 535 may be electrically connected to the first antenna array AR1 via the first feeding line 501 and/or the second feeding line 502, and may provide a feeding signal to the first antenna array AR1. The wireless communication circuit 535 may be electrically connected to the second antenna array AR2 via the third feeding line 603 and/or the fourth feeding line 604, and may provide a feeding signal to the second antenna array AR2.

According to various embodiments of the disclosure, the wireless communication circuit 535 may transmit and/or receive a first polarized signal (e.g., a vertically polarized signal) and a second polarized signal (e.g., a horizontally polarized signal) using the first antenna elements 511, 513, 515, and 517 of the first antenna array AR1. The wireless communication circuit 535 may also transmit and/or receive the first polarized signal (e.g., the vertically polarized signal) and the second polarized signal (e.g., the horizontally polarized signal) using the second antenna elements 521, 523, 525, and 527 of the second antenna array AR2.

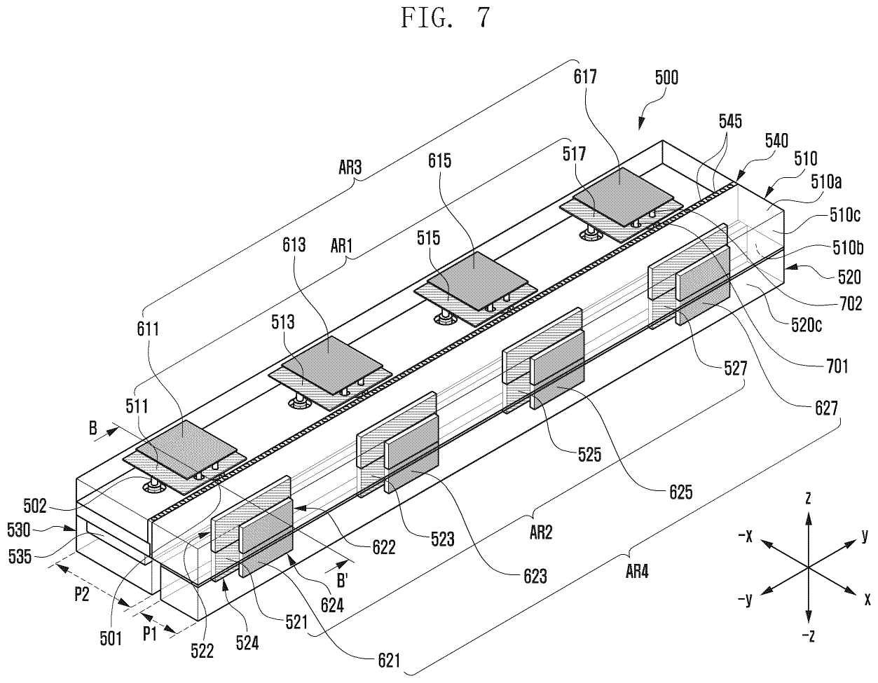

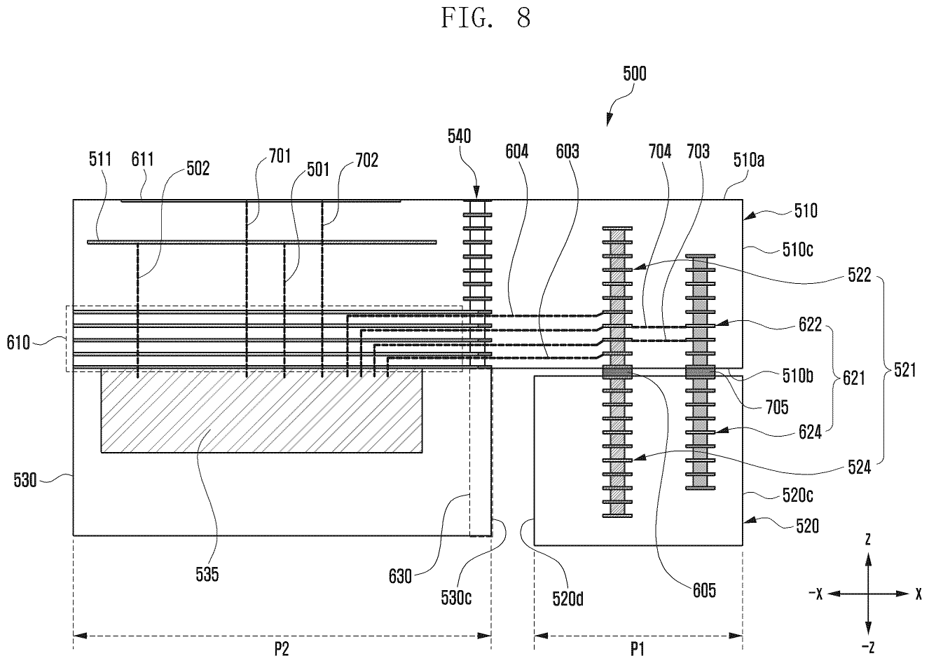

FIG. 7 is a perspective view schematically illustrating an antenna module according to an embodiment of the disclosure. FIG. 8 is a schematic cross-sectional view taken along line B-B′ of an antenna module illustrated in FIG. 7 according to an embodiment of the disclosure.

According to various embodiments of the disclosure, the antenna module 500 illustrated in FIGS. 7 and 8 may include the embodiment illustrated in FIGS. 5 and 6. For example, at least some of the components of the antenna module 500 illustrated in FIGS. 5 and 6 may be integrated into and/or applied to the antenna module 500 illustrated in FIGS. 7 and 8. In the description of the antenna module 500 illustrated in FIGS. 7 and 8, the same reference numerals may be used for components that are substantially the same as those illustrated in FIGS. 5 and 6, and redundant descriptions may be omitted.

Referring to FIGS. 7 and 8, an antenna module 500 according to various embodiments of the disclosure may include a first substrate 510, a second substrate 520, and/or a shielding member 530.

According to an embodiment of the disclosure, the first substrate 510 may include a first surface 510a (e.g., an upper surface) oriented in a first direction (e.g., the z-axis direction) and a second surface 510b (e.g., a lower surface) oriented in a second direction opposite to the first direction (e.g., the −z-axis direction). The second substrate 520 and the shielding member 530 may be disposed on the second surface 510b of the first substrate 510 (e.g., in the −z-axis direction).

According to an embodiment of the disclosure, the first substrate 510 may include a first antenna array AR1 (e.g., first antenna elements 511, 513, 515, and 517). For example, the first substrate 510 may include a first antenna array AR1 disposed therein. The first antenna array AR1 may include first antenna elements 511, 513, 515, and 517. For example, the first antenna array AR1 may be electrically connected to a wireless communication circuit 535 disposed in the shielding member 530 via a first feeding line 501 and/or a second feeding line 502.

According to various embodiments of the disclosure, the first antenna elements 511, 513, 515, and 517 of the first antenna array AR1 may be arranged at predetermined intervals inside the first substrate 510. For example, the first antenna elements 511, 513, 515, and 517 may be arranged on the first substrate 510 to form a beam pattern in the first direction (e.g., in the z-axis direction). The first antenna elements 511, 513, 515, and 517 may include a first conductive patch 511, a second conductive patch 513, a third conductive patch 515, and/or a fourth conductive patch 517. For example, the first conductive patch 511, the second conductive patch 513, the third conductive patch 515, and the fourth conductive patch 517 may each be electrically connected to the wireless communication circuit 535 via a first feeding line 501 and/or a second feeding line 502, and may transmit and/or receive a dual-polarized signal in the first direction of the antenna module 500 (e.g., in the z-axis direction).

According to various embodiments of the disclosure, FIG. 8 may be a schematic view of the antenna module illustrated in FIG. 7 taken along line B-B′, as viewed in the −y-axis direction. The first feeding line 501 and the second feeding line 502 described above may be disposed at the same or different positions in the y-axis direction. For example, FIG. 8 may schematically represent an embodiment in which the first feeding line 501 and the second feeding line 502 are disposed at different positions in the y-axis direction.

According to an embodiment of the disclosure, the first substrate 510 may include a third antenna array AR3 (e.g., third antenna elements 611, 613, 615, and 617). For example, the first substrate 510 may include a third antenna array AR3 disposed on or in an area adjacent to the first surface 510a (e.g., in the z-axis direction (the upper surface)). The third antenna array AR3 may include third antenna elements 611, 613, 615, and 617. The third antenna array AR3 may be electrically connected to the wireless communication circuit 535 via a fifth feeding line 701 and/or a sixth feeding line 702. For example, the wireless communication circuit 535 may transmit and/or receive a radio frequency in a range of about 3 GHz to 300 GHz using the third antenna array AR3.

According to various embodiments of the disclosure, the third antenna elements 611, 613, 615, and 617 of the third antenna array AR3 may be arranged at predetermined intervals on the first surface 510a of the first substrate 510 (e.g., in the z-axis direction) or in an area adjacent to the first surface 510a. For example, the third antenna elements 611, 613, 615, and 617 may be arranged on the first substrate 510 to form a beam pattern in the first direction (e.g., in the z-axis direction). The third antenna elements 611, 613, 615, and 617 may include a ninth conductive patch 611, a tenth conductive patch 613, an eleventh conductive patch 615, and/or a twelfth conductive patch 617.

According to various embodiments of the disclosure, the ninth conductive patch 611, the tenth conductive patch 613, the eleventh conductive patch 615, and/or the twelfth conductive patch 617 may have substantially the same shape or different shapes. The ninth conductive patch 611, the tenth conductive patch 613, the eleventh conductive patch 615, and the twelfth conductive patch 617 may receive a feeding signal from the wireless communication circuit 535 via at least one of, for example, a strip line, a microstrip line, a coplanar waveguide (CPW), or a via. For example, the ninth conductive patch 611, the tenth conductive patch 613, the eleventh conductive patch 615, and the twelfth conductive patch 617 may be electrically connected to the wireless communication circuit 535 via the fifth feeding line 701 and/or the sixth feeding line 702, and may transmit and/or receive a dual-polarized signal in the first direction (e.g., the z-axis direction) of the antenna module 500. For example, the dual-polarized signal may include a first polarized signal (e.g., a vertically polarized signal) and a second polarized signal (e.g., a horizontally polarized signal).

According to various embodiments of the disclosure, the fifth feeding line 701 and the sixth feeding line 702 described above may be disposed at the same position or different positions in the y-axis direction. For example, FIG. 8 may schematically illustrate an embodiment in which the fifth feeding line 701 and the sixth feeding line 702 are disposed at different positions in the y-axis direction.

According to various embodiments of the disclosure, the third antenna array AR3 may include the antenna array 430 illustrated in FIG. 4A. The third antenna elements 611, 613, 615, and 617 of the third antenna array AR3 may include the antenna elements 432, 434, 436, and 438 illustrated in FIG. 4A.

According to an embodiment of the disclosure, the first antenna array AR1 and the third antenna array AR3 may be spaced apart from each other and disposed on the first substrate 510. The first antenna array AR1 and the third antenna array AR3 may each transmit and/or receive polarized signals of ±90 degrees. According to various embodiments of the disclosure, the first antenna array AR1 and the third antenna array AR3 may each transmit and/or receive vertically and/or horizontally polarized signals in different frequency bands (e.g., about 28 GHZ and about 39 GHZ, respectively). For example, the first antenna array AR1 may transmit and/or receive a radio signal in a first frequency band (e.g., a band of about 3 GHz to 30 GHZ). For example, the third antenna array AR3 may transmit and/or receive a radio signal in a second frequency band (e.g., a band of about 30 GHz to 60 GHZ). For example, the third antenna array AR3 may transmit and/or receive a radio signal in a higher frequency band than the first antenna array AR1.

According to an embodiment of the disclosure, a first ground layer 610 may be disposed inside the first substrate 510. The first ground layer 610 may be disposed between the first antenna array AR1 and the second surface 510b of the first substrate 510. For example, the first ground layer 610 may include at least one layer. The first ground layer 610 may be disposed in parallel with the first antenna array AR land the third antenna array AR3 on the first substrate 510 (e.g., in a horizontal direction). The first ground layer 610 may be disposed to face the first antenna array AR1 and the third antenna array AR3. The first ground layer 610 may be a ground area provided for the radiation performance of the first antenna array AR1 and the third antenna array AR3.

According to an embodiment of the disclosure, the first substrate 510 may include at least a portion of a second antenna array AR2 (e.g., second antenna elements 521, 523, 525, and 527). For example, the first substrate 510 may include at least a portion of the second antenna array AR2 disposed inside a side surface 510c (e.g., in the x-axis direction). For example, a first portion 522 of the second antenna array AR2 may be disposed inside the first substrate 510. The second antenna array AR2 may include second antenna elements 521, 523, 525, and 527. The first portion 522 of the second antenna array AR2 may be electrically connected to the wireless communication circuit 535 via a third feeding line 603 and/or a fourth feeding line 604.

According to various embodiments of the disclosure, the third feeding line 603 and the fourth feeding line 604 described above may be disposed at the same position or different positions in the y-axis direction. For example, FIG. 8 may schematically illustrate an embodiment in which the third feeding line 603 and the fourth feeding line 604 are disposed at different positions in the y-axis direction.

In an embodiment of the disclosure, the second substrate 520 may include at least a portion of the second antenna array AR2. For example, the second substrate 520 may include a second antenna array AR2, at least a portion of which is disposed inside a side surface 520c (e.g., in the x-axis direction). For example, second portions 524 of the second antenna array AR2 may be disposed inside the second substrate 520. The first portions 522 of the second antenna array AR2 may be disposed on the first substrate 510, and the second portions 524 may be disposed on the second substrate 520. The first portions 522 and the second portions 524 of the second antenna array AR2 may be electrically connected via a first conductive connection member 605 (e.g., solder).

According to various embodiments of the disclosure, the first portions 522 of the second antenna array AR2 may be arranged at predetermined intervals inside a side surface 510c of the first substrate 510 (e.g., in the x-axis direction). The first portion 522 of a fifth conductive patch 521 (e.g., a fifth conductive element) of the second antenna array AR2 may be disposed inside the side surface 510c of the first substrate 510. The second portions 524 of the second antenna array AR2 may be arranged at predetermined intervals inside the side surface 520c of the second substrate 520 (e.g., in the x-axis direction). The second portion 524 of the fifth conductive patch 521 (e.g., the fifth conductive element) of the second antenna array AR2 may be disposed, for example, inside the side surface 520c of the second substrate 520.

According to various embodiments of the disclosure, the second antenna elements 521, 523, 525, and 527 of the second antenna array AR2 may be disposed on the first substrate 510 and the second substrate 520 to form a beam pattern in the lateral direction (e.g., in the x-axis direction) of the antenna module 500. The second antenna elements 521, 523, 525, and 527 may include a fifth conductive patch 521, a sixth conductive patch 523, a seventh conductive patch 525, and/or an eighth conductive patch 527. For example, the fifth conductive patch 521 may include a first portion 522 and a second portion 524. The sixth conductive patch 523, the seventh conductive patch 525, and the eighth conductive patch 527 may each include a first portion 522 and a second portion 524 that are substantially the same as those of the fifth conductive patch 521. In an embodiment of the disclosure, the first portions 522 and the second portions 524 may be formed using vias.

According to various embodiments of the disclosure, the fifth conductive patch 521, the sixth conductive patch 523, the seventh conductive patch 525, and/or the eighth conductive patch 527 may have substantially the same shape or different shapes. The fifth conductive patch 521, the sixth conductive patch 523, the seventh conductive patch 525, and the eighth conductive patch 527 may be electrically connected to the wireless communication circuit 535 via the third feeding line 603 and the fourth feeding line 604, and may transmit and/or receive a dual-polarized signal in the lateral direction (e.g., the x-axis direction) of the antenna module 500.

According to an embodiment of the disclosure, the first substrate 510 may include at least a portion of a fourth antenna array AR4 (e.g., fourth antenna elements 621, 623, 625, and 627). For example, the first substrate 510 may include at least a portion of the fourth antenna array AR4 disposed on or in an area adjacent to a side surface 510c (e.g., in the x-axis direction). For example, first portions 622 of the fourth antenna array AR4 may be disposed on the side surface 510c of the first substrate 510 (e.g., in the x-axis direction) or in an area adjacent to the side surface 510c. The fourth antenna array AR4 may include fourth antenna elements 621, 623, 625, and 627. The first portions 622 of the fourth antenna array AR4 may be electrically connected to the wireless communication circuit 535 via a seventh feeding line 703 and/or an eighth feeding line 608.

According to various embodiments of the disclosure, the seventh feeding line 703 and the eighth feeding line 704 described above may be disposed at the same position or different positions in the y-axis direction. For example, FIG. 8 may schematically illustrate an embodiment in which the seventh feeding line 703 and the eighth feeding line 704 are disposed at different positions in the y-axis direction.

In an embodiment of the disclosure, the second substrate 520 may include at least a portion of the fourth antenna array AR4. For example, the second substrate 520 may include the fourth antenna array AR4, at least a portion of which is disposed on a side surface 520c (e.g., in the x-axis direction) or in an area adjacent to the side surface 520c. For example, second portions 624 of the fourth antenna array AR4 may be disposed on the side surface 520c of the second substrate 520 (e.g., in the x-axis direction) or in an area adjacent to the side surface 520c. The first portions 622 of the fourth antenna array AR4 may be disposed on the first substrate 510, and the second portions 624 may be disposed on the second substrate 520. The first portions 622 and the second portions 624 of the second antenna array AR4 may be electrically connected via a second conductive connection member 705 (e.g., solder).

According to various embodiments of the disclosure, the first portions 622 of the fourth antenna array AR4 may be arranged at predetermined intervals on a side surface 510c of the first substrate 510 (e.g., in the x-axis direction) or in an area adjacent to the side surface 510c. The first portion 622 of a thirteenth conductive patch 621 (e.g., a thirteenth conductive element) of the fourth antenna array AR4 may be disposed, for example, on the side surface 510c of the first substrate 510 or in an area adjacent to the side surface 510c. The second portions 624 of the fourth antenna array AR4 may be arranged at predetermined intervals on a side surface 520c of the second substrate 520 (e.g., in the x-axis direction) or in an area adjacent to the side surface 520c. The second portion 624 of the thirteenth conductive patch 621 (e.g., the thirteenth conductive element) of the fourth antenna array AR4 may be disposed, for example, on the side surface 520c of the second substrate 520 or in an area adjacent to the side surface 520c.

According to various embodiments of the disclosure, the fourth antenna elements 621, 623, 625, and 627 of the fourth antenna array AR4 may be disposed on the first substrate 510 and the second substrate 520 to form a beam pattern in the lateral direction (e.g., in the x-axis direction) of the antenna module 500. The fourth antenna elements 621, 623, 625, and 627 may include a thirteenth conductive patch 621, a fourteenth conductive patch 623, a fifteenth conductive patch 625, and/or a sixteenth conductive patch 627. For example, the thirteenth conductive patch 621 may include a first portion 622 and a second portion 624. The fourteenth conductive patch 623, the fifteenth conductive patch 625, and sixteenth conductive patch 627 may each include a first portion 622 and a second portion 624 that are substantially the same as those of the fifth conductive patch 521. In an embodiment of the disclosure, the first portions 622 and the second portions 624 may be formed using vias.

According to various embodiments of the disclosure, the thirteenth conductive patch 621, the fourteenth conductive patch 623, the fifteenth conductive patch 625, and/or the sixteenth conductive patch 627 may have substantially the same shape or different shapes. The thirteenth conductive patch 621, the fourteenth conductive patch 623, the fifteenth conductive patch 625, and the sixteenth conductive patch 627 may receive a feeding signal from the wireless communication circuit 535 via at least one of, for example, a strip line, a microstrip line, a coplanar waveguide (CPW), or a via. For example, the thirteenth conductive patch 621, the fourteenth conductive patch 623, the fifteenth conductive patch 625, and the sixteenth conductive patch 627 may be electrically connected to the wireless communication circuit 535 via the seventh feeding line 703 and the eighth feeding line 704, and may transmit and/or receive a dual-polarized signal in the lateral direction (e.g., the x-axis direction) of the antenna module 500.

According to various embodiments of the disclosure, the fourth antenna array AR4 may include the antenna array 430 illustrated in FIG. 4A. The fourth antenna elements 621, 623, 625, and 627 of the fourth antenna array AR4 may include the antenna elements 432, 434, 436, and 438 illustrated in FIG. 4A.

According to an embodiment of the disclosure, the second antenna array AR2 and the fourth antenna array AR4 may be spaced apart from each other and disposed on the first substrate 510 and the second substrate 520. The second antenna array AR2 and the fourth antenna array AR4 may each transmit and/or receive polarized signals of ±90 degrees. For example, the second antenna array AR2 may transmit and/or receive a radio signal in a first frequency band (e.g., a band of about 3 GHz to 30 GHZ). The fourth antenna array AR4 may transmit and/or receive a radio signal in a second frequency band (e.g., a band of about 30 GHz to 60 GHZ). For example, the fourth antenna array AR4 may transmit and/or receive a radio signal in a higher frequency band than the second antenna array AR2.

According to an embodiment of the disclosure, a second ground layer 540 may be disposed inside the first substrate 510. The second ground layer 540 may include at least one via 545. The second ground layer 540 may be disposed between the first antenna array AR1 and the second antenna array AR2. The second ground layer 540 may be disposed between the third antenna array AR3 and the fourth antenna array AR4. The second ground layer 540 may include a plurality of vias 545. The second ground layer 540 may be disposed in parallel (e.g., in the z-axis direction) with the first portions 522 of the second antenna array AR2 and the first portions 622 of the fourth antenna array AR4, which are disposed on a side surface 510c of the first substrate 510 (e.g., in the x-axis direction). The second ground layer 540 may be disposed to face the first portions 522 of the second antenna array AR2 and the first portions 622 of the fourth antenna array AR4. The second ground layer 540 may be a ground area provided for the radiation performance of the first portions 522 of the second antenna array AR2 and the first portions 622 of the fourth antenna array AR4.

According to an embodiment of the disclosure, the second substrate 520 may be disposed at a first position P1, which is in a partial direction (e.g., the x-axis direction) of the second surface 510b of the first substrate 510 (e.g., in the −z-axis direction). The shielding member 530 may be disposed at a second position P2, which is in a direction (e.g., the −x-axis direction opposite to the partial direction (e.g., the x-axis direction) of the second surface 510b of the first substrate 510 (e.g., in the −z-axis direction). The second substrate 520 and the shielding member 530 may be disposed adjacent to each other. For example, the side surface 520d of the second substrate 520 and the side surface 530c of the shielding member 530 may be disposed to face each other.

In an embodiment of the disclosure, the shielding member 530 may include therein a wireless communication circuit 535, a power management module (e.g., the power management module 188 of FIG. 1), and/or at least one lumped element (e.g., a resistor, an inductor, and/or a capacitor). The shielding member 530 may include a conductive material. For example, the shielding member 530 may include a conductive shield can. When the shielding member 530 is made of a conductive material, a portion 630 of the shielding member 530 may serve as a ground for the second portions 524 of the second antenna array AR2 and the second portions 624 of the fourth antenna array AR4. For example, the portion 630 of the shielding member 530 may function as a third ground layer. The portion 630 of the shielding member 530 may be disposed between the wireless communication circuit 535 and the second portions 524 of the second antenna array AR2.

According to various embodiments of the disclosure, the shielding member 530 may include a non-conductive material and/or a conductive material. For example, the portion 630 of the shielding member 530 may include a conductive material. The conductive material included in the portion 630 of the shielding member 530 may serve as a ground (e.g., a third ground layer) for the second portions 524 of the second antenna array AR2 and the second portions 624 of the fourth antenna array AR4. In an embodiment of the disclosure, the portion 630 of the shielding member 530 may be electrically connected to the second ground layer 540.

According to an embodiment of the disclosure, the wireless communication circuit 535 disposed inside the shielding member 530 may be configured to process signals in a frequency band transmitted and/or received through the first antenna array AR1, the second antenna array AR2, the third antenna array AR3, and the fourth antenna array AR4. For example, during transmission, the wireless communication circuit 535 may convert a baseband signal and/or an intermediate frequency signal into a radio frequency (RF) signal of a predetermined band. During reception, the wireless communication circuit 535 may convert an RF signal received through the first antenna array AR1, the second antenna array AR2, the third antenna array AR3, and/or the fourth antenna array AR4 into a baseband signal and/or an intermediate frequency signal and output the converted signal. For example, referring to FIG. 8, the wireless communication circuit 535 may be electrically connected to the first antenna array AR1 via the first feeding line 501 and/or the second feeding line 502, and may provide a feeding signal to the first antenna array AR1. The wireless communication circuit 535 may be electrically connected to the second antenna array AR2 via the third feeding line 603 and/or the fourth feeding line 604, and may provide a feeding signal to the second antenna array AR2. The wireless communication circuit 535 may be electrically connected to the third antenna array AR3 via the fifth feeding line 701 and/or the sixth feeding line 702, and may provide a feeding signal to the third antenna array AR3. The wireless communication circuit 535 may be electrically connected to the fourth antenna array AR4 via the seventh feeding line 703 and/or the eighth feeding line 704, and may provide a feeding signal to the fourth antenna array AR4.

According to various embodiments of the disclosure, the wireless communication circuit 535 may transmit and/or receive a first polarized signal (e.g., a vertically polarized signal) and a second polarized signal (e.g., a horizontally polarized signal) using the first antenna elements 511, 513, 515, and 517 of the first antenna array AR1. The wireless communication circuit 535 may also transmit and/or receive the first polarized signal (e.g., the vertically polarized signal) and the second polarized signal (e.g., the horizontally polarized signal) using the second antenna elements 521, 523, 525, and 527 of the second antenna array AR2. The wireless communication circuit 535 may also transmit and/or receive the first polarized signal (e.g., the vertically polarized signal) and the second polarized signal (e.g., the horizontally polarized signal) using the third antenna elements 611, 613, 615, and 617 of the third antenna array AR3. The wireless communication circuit 535 may also transmit and/or receive the first polarized signal (e.g., the vertically polarized signal) and the second polarized signal (e.g., the horizontally polarized signal) using the fourth antenna elements 621, 623, 625, and 627 of the fourth antenna array AR4.

According to various embodiments of the disclosure, by utilizing a portion 630 of the shielding member 530 included in the antenna module 500 as a ground area for the second portions 524 of the second antenna array AR2 and/or the second portions 624 of the fourth antenna array AR4, for example, the width of the second substrate 520 may be reduced.

According to an embodiment of the disclosure, an electronic device 101 or 300 may include a housing 310 including a first surface 310A, a second surface 310B, and a side surface 310C surrounding a space between the first surface 310A and the second surface 310B, and an antenna module 500 disposed inside the housing 310. According to an embodiment of the disclosure, the antenna module 500 may include a wireless communication circuit 535, a first substrate 510 including a first surface 510a oriented in a first direction and a second surface 510b oriented in a second direction opposite to the first direction, wherein, on the first substrate, first antenna elements 511, 513, 515, and 517 and first portions 522 of second antenna elements 521, 523, 525, and 527 are disposed, a second substrate 520 disposed at a first position P1 of the second surface 510b of the first substrate 510, wherein, on the second substrate, second portions 524 of the second antenna elements 521, 523, 525, and 527 are disposed, and a shielding member 530 disposed adjacent to the second substrate 520 at a second position P2 of the second surface 510b of the first substrate 510. According to an embodiment of the disclosure, a portion 630 of the shielding member 530 may be configured to serve as a ground for the second portions 524 of the second antenna elements 521, 523, 525, and 527.

According to an embodiment of the disclosure, the first portions 522 and the second portions 524 of the second antenna elements 521, 523, 525, and 527 may be electrically connected via a conductive connection member 605.

According to an embodiment of the disclosure, the portion 630 of the shielding member 530 may include a conductive material.

According to an embodiment of the disclosure, the shielding member 530 may include a conductive shield can.

According to an embodiment of the disclosure, the first antenna elements 511, 513, 515, and 517 may be electrically connected to the wireless communication circuit 535 via a first feeding line 501 and a second feeding line 502. According to an embodiment of the disclosure, the first portions 522 of the second antenna elements 521, 523, 525, and 527 may be electrically connected to the wireless communication circuit 535 via a third feeding line 603 and/or a fourth feeding line 604.

According to an embodiment of the disclosure, the first antenna elements 511, 513, 515, and 517 may be configured to transmit and/or receive a first polarized signal and a second polarized signal in the first direction. According to an embodiment of the disclosure, the second antenna elements 521, 523, 525, and 527 may be configured to transmit and/or receive a first polarized signal and a second polarized signal in the lateral direction of the antenna module 500.

According to an embodiment of the disclosure, the antenna module 500 may include a first ground layer 610 disposed between the first antenna elements 511, 513, 517, and 519 and the second surface 510b of the first substrate 510.

According to an embodiment of the disclosure, the antenna module 500 may include a second ground layer 540 disposed between the first antenna elements 511, 513, 515, and 517 and the second antenna elements 521, 523, 527, and 529.

According to an embodiment of the disclosure, the antenna module 500 may include third antenna elements 611, 613, 615, and 617 disposed on the first substrate 510 and spaced apart from the first antenna elements 511, 513, 515, and 517, first portions 622 of fourth antenna elements 621, 623, 625, and 627 disposed on the first substrate 510 and spaced apart from first portions 522 of the second antenna elements 521, 523, 525, and 527, and second portions 624 of the fourth antenna elements 621, 623, 625, and 627 disposed on the second substrate 520 and spaced apart from second portions 524 of the second antenna elements 521, 523, 525, and 527.

According to an embodiment of the disclosure, the third antenna elements 611, 613, 615, and 617 may be electrically connected to the wireless communication circuit 535 via a fifth feeding line 701 and/or a sixth feeding line 702. According to an embodiment of the disclosure, the first portions 622 of the fourth antenna elements 621, 623, 625, and 627 may be electrically connected to the wireless communication circuit 535 via a seventh feeding line 703 and/or an eighth feeding line 704.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing comprising a first surface, a second surface, and a side surface surrounding a space between the first surface and the second surface; and
an antenna module disposed inside the housing,
wherein the antenna module comprises:
a wireless communication circuit,
a first substrate comprising a first surface oriented in a first direction and a second surface oriented in a second direction opposite to the first direction, wherein, on the first substrate, first antenna elements and first portions of second antenna elements are disposed,
a second substrate disposed at a first position of the second surface of the first substrate, wherein second portions of the second antenna elements are disposed on the second substrate, and
a shielding member disposed adjacent to the second substrate at a second position of the second surface of the first substrate, and
wherein a portion of the shielding member is configured to serve as a ground for the second portions of the second antenna elements.

2. The electronic device of claim 1, wherein the first portions and the second portions of the second antenna elements are electrically connected via a conductive connection member.

3. The electronic device of claim 1, wherein the portion of the shielding member comprises a conductive material.

4. The electronic device of claim 3, wherein the shielding member comprises a conductive shield can.

5. The electronic device of claim 1,
wherein the first antenna elements are electrically connected to the wireless communication circuit via a first feeding line and/or a second feeding line, and
wherein the first portions of the second antenna elements are electrically connected to the wireless communication circuit through a third feeding line and/or a fourth feeding line.

6. The electronic device of claim 5,
wherein the first antenna elements are configured to transmit and/or receive a first polarized signal and a second polarized signal in the first direction, and
wherein the second antenna elements are configured to transmit and/or receive the first polarized signal and the second polarized signal in a lateral direction of the antenna module.

7. The electronic device of claim 1, further comprising:
a first ground layer is disposed between the first antenna elements and the second surface of the first substrate.

8. The electronic device of claim 1, further comprising a second ground layer is disposed between the first antenna elements and the second antenna elements.

9. The electronic device of claim 1, further comprising:
third antenna elements spaced apart from the first antenna elements and disposed on the first substrate;
first portions of fourth antenna elements spaced apart from the first portions of the second antenna elements and disposed on the first substrate; and
second portions of the fourth antenna elements spaced apart from the second portions of the second antenna elements and disposed on the second substrate.

10. The electronic device of claim 9,
wherein the third antenna elements are electrically connected to the wireless communication circuit via a fifth feeding line and/or a sixth feeding line, and
wherein the first portions of the fourth antenna elements are electrically connected to the wireless communication circuit via a seventh feeding line and/or an eighth feeding line.

11. An antenna module comprising:
a wireless communication circuit;
a first substrate comprising a first surface oriented in a first direction and a second surface oriented in a second direction opposite to the first direction, wherein, on the first substrate, first antenna elements and first portions of second antenna elements are disposed;
a second substrate disposed at a first position of the second surface of the first substrate, wherein, on the second substrate, second portions of the second antenna elements are disposed; and
a shielding member disposed adjacent to the second substrate at a second position of the second surface of the first substrate,
wherein a portion of the shielding member is configured to serve as a ground for the second portions of the second antenna elements.

12. The antenna module of claim 11, wherein the first portions and the second portions of the second antenna elements are electrically connected via a conductive connection member.

13. The antenna module of claim 11, wherein the portion of the shielding member comprises a conductive material.

14. The antenna module of claim 13, wherein the shielding member comprises a conductive shield can.

15. The antenna module of claim 11,
wherein the first antenna elements are electrically connected to the wireless communication circuit via a first feeding line and/or a second feeding line, and
wherein the first portions of the second antenna elements are electrically connected to the wireless communication circuit through a third feeding line and/or a fourth feeding line.

16. The antenna module of claim 15,
wherein the first antenna elements are configured to transmit and/or receive a first polarized signal and a second polarized signal in the first direction, and
wherein the second antenna elements are configured to transmit and/or receive the first polarized signal and the second polarized signal in a lateral direction of the antenna module.

17. The antenna module of claim 11, further comprising:
a first ground layer is disposed between the first antenna elements and the second surface of the first substrate.

18. The antenna module of claim 11, further comprising a second ground layer is disposed between the first antenna elements and the second antenna elements.

19. The antenna module of claim 11, further comprising:
third antenna elements spaced apart from the first antenna elements and disposed on the first substrate;
first portions of fourth antenna elements spaced apart from the first portions of the second antenna elements and disposed on the first substrate; and
second portions of the fourth antenna elements spaced apart from the second portions of the second antenna elements and disposed on the second substrate.

20. The antenna module of claim 19,
wherein the third antenna elements are electrically connected to the wireless communication circuit via a fifth feeding line and/or a sixth feeding line, and
wherein the first portions of the fourth antenna elements are electrically connected to the wireless communication circuit via a seventh feeding line and/or an eighth feeding line.
